(19) United States
(12) Patent Application Publication
(10) Pub. No.: US 2005/0198271 A1
(43) Pub. Date: Sep. 8, 2005

(54) Method and system for network jack location mapping and maintaining coherence of information

(76) Inventor: Alan Rubinstein, Fremont, CA (US)

Correspondence Address: WAGNER, MURABITO & HAO LLP, Third Floor, Two North Market Street, San Jose, CA, 95113, US

(21) Appl. No.: 10/785,437

(22) Filed: Feb. 23, 2004

(51) Int. Cl. G06F 15/173

(52) U.S. Cl. 709/224

(57) ABSTRACT

A method and system for maintaining coherence of location information in a database of a distributed network of network jack units are disclosed. The method includes initially configuring the location information accurately, upon which the distributed network is monitored. Upon detecting a change in the distributed network, the significance of that change on the coherence of the location information is assessed. Upon determining that the change is significant, an action is initiated to update the database and/or take other corrective action.

### TECHNICAL FIELD

The present invention generally pertains to the field of networked computers. More particularly, embodiments of the present invention are related to a method and system for enhancing the coherence of a locational database associated with a network.

### BACKGROUND

Modern computing networks allow great benefits by sharing information and computing resources. Such networks have a great variety of applications. In some of these applications, locational information can be valuable. For instance, locational information can be important, even crucial, in networks used for emergency response services (ERS).

ERS networks include ‘911’ services, in which for instance, in response to a call placed by a person to a ‘911’ telephone number, an ERS network operator is telephonically connected with the person. The person placing the call can then communicate with the ERS operator, who can summon or dispatch ERS personnel and/or units to assist the person placing the ‘911’ call.

Locational information relating to the person placing the ‘911’ call, such as a physical address (e.g., of a residential, commercial, phone booth, roadside assistance phone, or other property or place) is automatically made available to the ERS operator. ERS personnel can thus be apprised of the location from which the ‘911’ call was made, in case the person placing the call is unable to provide it.

Such automatic availability can be achieved by several means. One example is automatically accessing a database wherein the telephone number from which the ‘911’ call was placed is mapped to an address or other locational information and displaying that information on a monitor for the ERS operator and/or for the dispatched or summoned units.

Partly in response to the growth of computer based networking, enhanced ERS services, such as enhanced ‘911’ (E911) services are becoming desirable. E911 services should be able to automatically provide accurate locational information relating to a ‘911’ caller, even if the ‘911’ call is not placed by conventional telephony. For instance, a ‘911’ call may be placed using voice over internet protocol (VOIP).

VOIP may be used with telephones and other equipment, which can be physically connected to a network using network jacks. Locational information to be provided in response to a VOIP placed ‘E911’ call can be ascertained in a manner similar to that discussed above. The location accessed from the database in this example could be the physical location of the network jack through which the ‘E911’ call is placed.

ERS networks are by no means the only networks in which locational information can be valuable. Networks have become commonplace in business, government, hospital, educational, and other enterprises and institutions. In fact, their use continues to grow and expand. In some of these networks as well, locational information relating to devices connected to the network can also be valuable.

For instance, large, modern office complexes (e.g., campuses) may comprise multiple buildings. Where locational information in such an office coplex is tied to a port on a telephone or infrastructure switch, movement of the equipment so tied, and/or swapping of ports can cause confusion and possible errors in the database.

Such devices can also be connected to networks using network jacks. Knowing the location of the network jacks through which various devices are connected to a network can be used to locate the equipment connected there through. For instance, some modern medical equipment such as a portable X-Ray machine can be connected through network jacks to a network in a hospital.

In a large hospital, it may become expedient to locate the portable X-Ray machine over the hospital's network. A query can be broadcast over the network for the device having an identifier corresponding to the network interface card (NIC) or media access control layer (MAC) address to respond. Upon that unit responding, the network jack through which it responded can be ascertained.

Knowing the location of that network jack can allow the device being sought to be tracked down. Conventionally, the location of network jacks can be recorded upon their installation. Their locations can be databased. The database can be accessed any time thereafter, such as while seeking the portable device, when the location corresponding to that network jack must be determined.

The databased location of network jacks can be incorrect however. For instance, the location of network jacks can change over time. The network jacks can be moved, replaced, and/or swapped with another network jack. Thus, the information in a database that corresponds to the location of a network jack can become inaccurate (e.g., corrupt) over time.

Inaccuracy relating to the databased location of network jacks can be inconvenient. For example, the X-Ray machine may prove difficult to find, with technicians “leading a wild goose chase” for it. This can be troubling if that particular X-Ray unit is needed. However, such inaccuracy can conceivably have tragic results. Consider for instance the ramifications of a botched response to an ‘E911’ call.

### SUMMARY

Coherence can be desirable in a database of a distributed network of network jack units. Accurate location information can be desirable for initial configuration. It could be desirable to monitor the network with such information. If a change in the distributed network is detected, it would be desirable to assess the significance of that change on the coherence of the location information. An action to update the database could be desirable, as could other corrective action, where such changes are detected deemed significant.

A method and system for maintaining coherence of location information in a database, which can be centralized, of a distributed network of network jack units are disclosed. The method includes initially configuring the location information accurately, after which the distributed network is monitored. Monitoring can be performed by a central and/or redundant management entity. Upon detecting a change in the distributed network, the significance of that change on the coherence of the location information is assessed. Upon determining that the change is significant, an action is initiated to update the database and/or take other corrective action.

In one embodiment, the location data is accurately configured initially by accurately entering location information at one of the network jack units. That location information is provided to the database. This can be performed for instance by uploading the location information from the network jack unit over the network or transferring the location information from a storage entity such as a portable data storage device.

Such portable storage devices include, but are not limited to, a computer (including a computer used to enter the location data), a dedicated data storage and transfer entity, or a portable data storage medium, such as a compact disc, diskette, universal serial bus (USB) port data loader, or the like.

In one embodiment, detecting a change in the distributed network comprises discovering that one of the network jack units lacks locally associated location information. Assessing the significance of this change can comprise inferring that the network jack unit does not have location information entered therein. This can be corrected by providing that information to the network jack unit.

In one embodiment, detecting a change in the distributed network comprises discovering that one of the network jack units has locally associated location information which seems to be new. Assessing the significance of this change can comprise inferring that the network jack unit can have location information entered therein that is incorrect. Appropriate corresponding actions can include alerting that the location information can be corrupt and correcting it.

In one embodiment, detecting a change in the distributed network comprises discovering that a media access control (MAC) address of one of the network jack units differs from a MAC address listed for that network jack in the database. Assessing the significance of this change can comprise inferring that the network jack unit can have had correct location information entered therein that is incorrect. One appropriate corresponding action can include updating the database.

One embodiment provides a method for monitoring a distributed network of network jack units to maintain coherence of location information in a database of the network. This method can comprise polling one of the network jack units wherein the network jack unit has been known (e.g., previously) to a management entity performing the monitoring. Upon detecting no response to the polling, a reconnect event relating to that network jack unit is watched for. Upon detecting a reconnect event, the identity of the network jack unit is checked.

In one embodiment, upon detecting that the identity differs from a value for an identity associated with the network jack unit that is stored in the database, it is inferred that the location information can be corrupt. A corresponding alert can be sent and an action can be taken to investigate and correct the location information.

This method can also comprise detecting a power loss to one of the network jack units and verifying the location information as related to that unit. In this embodiment, the method further comprises detecting an event and responsively checking for an indication of a power loss. The event can comprise a reboot event. If so, a power loss flag in a non-volatile memory can be sought, or a memory location which initiates with a pattern that corrupts on a power loss can be checked.

This method can also comprise detecting an attempt to move one of the network jack units. In this case, the frequency of monitoring the network jack unit, such as for a disconnect transaction, can be increased. The network jack unit can include a tamper sensor which can generate a detectable signal if an attempt is made to, for instance, remove mounting hardware, or another action indicative of a moving attempt is taken.

In one embodiment, the method can comprise detecting a change among table associations, such as in an infrastructure switch or management entity, and responsively performing a location mapping check. Upon detecting a location mapping change, it can be inferred that the network jack unit was selectively upgraded and replaced, and the database can be updated. Upon detecting no location mapping change, another port can be checked. Upon detecting a port swap, a management entity can be alerted.

### BRIEF DESCRIPTION OF THE DRAWINGS

The accompanying drawings, which are incorporated in and form a part of this specification, illustrate embodiments of the invention and, together with the description, serve to explain the principles of the invention.

FIG. 1 depicts a network environment, according to one embodiment of the present invention.

FIG. 2 depicts a network jack, coupling a device to a network, according to one embodiment of the present invention.

FIG. 3 depicts an intelligent network jack, according to one embodiment of the present invention.

FIG. 4 is a flowchart of a process for maintaining coherence in a network locational database, according to an embodiment of the present invention.

FIG. 5 is a flowchart of a process for initially accurately configuring network jack location information, according to an embodiment of the present invention.

FIG. 6 is a flowchart of a process for detecting corruption of location information after installation of a network jack, according to one embodiment of the present invention.

FIG. 7 is a flowchart of an exemplary process for detecting new location mapping information after installation of a network jack, according to one embodiment of the present invention.

FIG. 8 is a flowchart of an exemplary process for confirming location information upon a disconnect/reconnect event, according to one embodiment of the present invention.

FIG. 9 is a flowchart of an exemplary process for verifying location information and active status of a network jack unit of a distributed network of network jack units, according to one embodiment of the present invention.

FIG. 10 is a flowchart of an exemplary process for detecting a power loss in a distributed network of network jack units, according to one embodiment of the present invention.

FIG. 11 is a flowchart of an exemplary process for detecting an attempt to move a network jack unit, according to one embodiment of the present invention.

FIG. 12 is a flowchart of an exemplary process for verifying location mapping upon a client event, such as a client disconnect/reconnect, according to one embodiment of the present invention.

FIG. 13 is a flowchart of an exemplary process for discriminating between a benign network configuration changes and those which can imply possible location information corruption, according to one embodiment of the present invention.

FIG. 14 is a flowchart of an exemplary process for inferring possible corruption of location information from information relating to an outage duration.

### DETAILED DESCRIPTION

A method and system for maintaining coherence of location information in a database of a distributed network of network jack units are disclosed. Reference will now be made in detail to embodiments of the present invention, examples of which are illustrated in the accompanying drawings. While the invention will be described in conjunction with these embodiments, it is to be understood that they are not intended to limit the invention to these embodiments. On the contrary, the invention is intended to cover alternatives, modifications and equivalents, which may be included within the spirit and scope of the invention as defined by the appended claims.

Furthermore, in the following detailed description of these embodiments, numerous specific details are set forth in order to provide a thorough understanding of the present invention. However, it will be apparent to one of ordinary skill in the art that an embodiment of the present invention may be practiced without these particular specific details. In other instances, well known methods, procedures, networks, programs, devices, components, and circuits have not been described in detail, so as not to unnecessarily obscure aspects of the present invention.

Some portions of the detailed descriptions which follow are presented in terms of procedures, logic blocks, processing, and other symbolic representations of operations on data bits within a computer memory. These descriptions and representations are the means used by those skilled in the data processing arts to most effectively convey the substance of their work to others skilled in the art. In the present application, a procedure, logic block, process, etc., is conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proved convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “maintaining”, “calculating”, “computing”, “configuring”, “monitoring”, “detecting”, “assessing”, “initiating”, “acting”, “entering”, “providing”, “uploading”, “transferring”, “managing”, “controlling”, “discovering”, “alerting”, “correcting”, “polling”, “watching”, “checking”, “inferring”, “sending”, “investigating”, “verifying”, “increasing”, “generating”, “updating”, “sending”, “receiving”, or the like, refer to the actions and processes of a computer system, or similar electronic computing device.

The computer system or similar electronic computing device manipulates and transforms data represented as physical (electronic) quantities within the computer system's registers and memories into other data similarly represented as physical quantities within the computer system memories or registers or other such information storage, transmission, or display devices. The present invention is also well suited to the use of other computer systems such as, for example, optical computers.

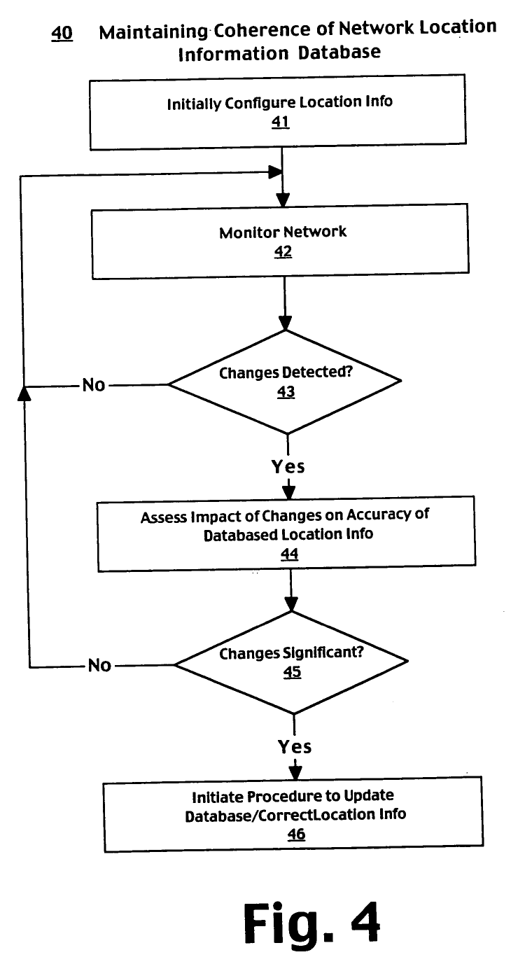

Further, various embodiments of the present invention may be discussed in terms of processes, e.g., the implementation and/or execution of a method. For example, FIGS. 4-14, all flowcharts, and the text rendering an accompanying discussion thereof, refers to processes 40-90, 10, and 1100-1400, respectively, performed in accordance with respective embodiments of the present invention for detecting spoofing by a variety of ways. Flowcharts 4-14, and the text rendering an accompanying discussion thereof, include exemplary processes of respective embodiments of the present invention which, in one embodiment, are carried out by processors and electrical/electronic components under the control of computer readable and computer executable instructions.

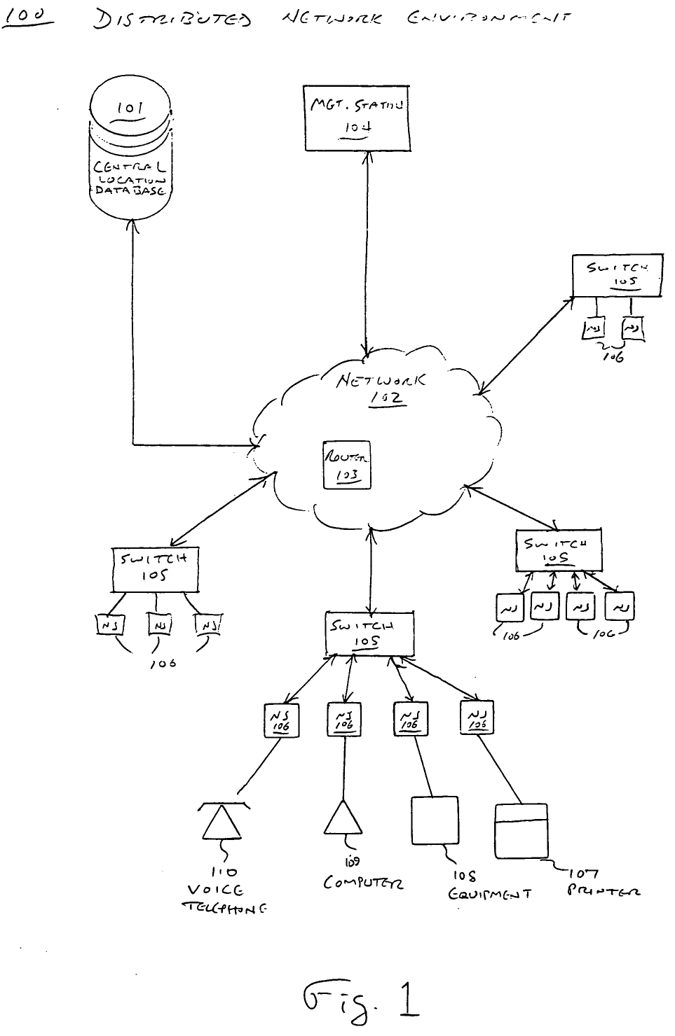

The computer readable and computer executable instructions reside, for example, in data storage features, memory, caches, and processors of a computer comprising management entity 104 (FIG. 1). However, the computer readable and computer executable instructions may reside in any type of computer readable medium. Although specific processes are disclosed in FIGS. 4-14, such processes are exemplary. That is, embodiments of the present invention are well suited to performing various other processes or variations of the processes including other steps or sequences of steps than those recited in FIGS. 4-14. Within the present embodiment, it should be appreciated that the process of the flowcharts rendered in FIGS. 4-14 and their processes, may be performed by, e.g., executed upon software, firmware, and/or hardware or any combination of software, firmware, and/or hardware.

A method and system for maintaining coherence of location information in a database, which can be centralized, of a distributed network of network jack units are disclosed. The method includes initially configuring the location information accurately, upon which the distributed network is monitored. Monitoring can be performed by a central and/or redundant management entity. Upon detecting a change in the distributed network, the significance of that change on the coherence of the location information is assessed. Upon determining that the change is significant, an action is initiated to update the database and/or take other corrective action. Thus, coherence can be maintained in a database of a distributed network of network jack units. Accurate location information can be is initially configured for monitoring the network. If a change in the distributed network is detected, the significance of that change on the coherence of the location information is assessed. An action to update the database and other corrective action can be taken. Applications depending upon accurate, coherent location information, such as for equipment tracking, enhanced emergency response services, and other utilities can be so provided.

Exemplary Network Environment and Components

FIG. 1 depicts a distributed network environment 100, according to one embodiment of the present invention. Network environment 100 comprises a distributed network of network jacks 106. Within network environment 100, a central database 101 contains information relating to the location of network jacks 106. Central database 101 can be accessed, for instance by a management station 104, via a network 102.

Network 102 can be any type of network. For instance, network 102 can be an institutional or other intranet. Network 102 can be a wide area network (WAN), a local area network (LAN), or the Internet. Network 102 is managed (e.g., controlled, including as to configuration, administrated, etc.) in one embodiment by management center 104.

Within and/or through network 102, network traffic can be routed between central database 101, management station 104, and/or any of switches 105 and any components or devices 125 coupled through them. Devices 125 are connected to the network switches via network jacks 106. Traffic can be routed through network 102 at least in part by a router 105.

Devices 125 include any devices capable of network coupling through a network jack 106. Such devices are exemplified herein by voice telephone 110, a laptop, desktop, or other computer 109, a network capable piece of equipment 108, which can be portable, and a printer 107. Devices 107-110 are exemplary of and are not to be construed as limiting devices 125.

Any devices capable of network coupling can comprise devices 125. Devices 125 each have a unique identity, which can be expressed by one or more of several unique identifiers. Such identifiers are known in the art. Examples include Internet Protocol (IP) addresses associated with a network interface card (NIC) and media access control (MAC) card identity numbers.

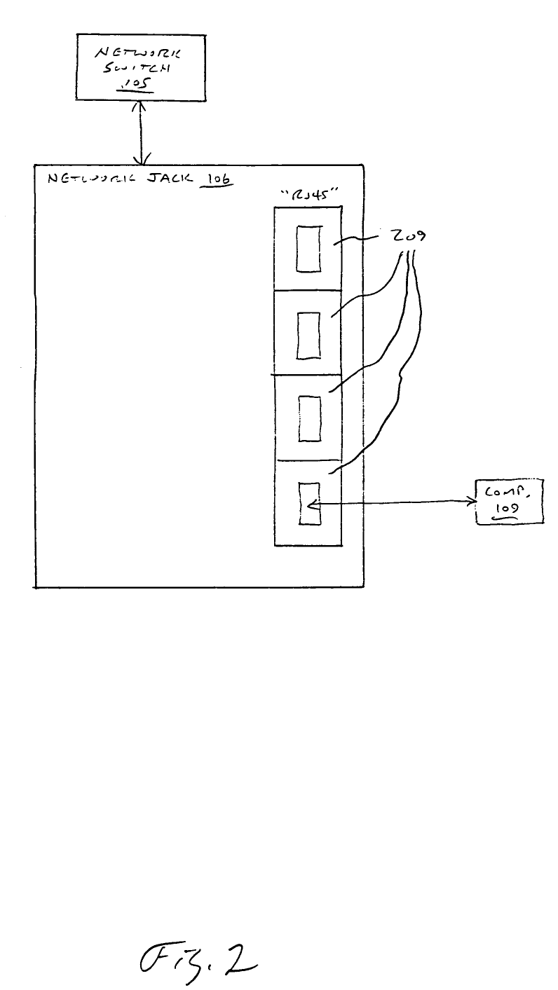

Such unique identifiers are used, in one embodiment, to determine an identity for a particular device 125 connected through a network jack 106. FIG. 2 depicts a network jack 106, coupling a device 125 to network 102 (FIG. 1) through network switch 105, according to one embodiment of the present invention.

Connections of devices 105 are made with network jack 106, in one embodiment, by any of connection receptacles (e.g., ports) 209. In one embodiment, connection receptacles 209 comprise RJ45 connectors. However, it is appreciated that the present invention is not limited to any particular connector configuration or type.

Referring again to FIG. 1, central database 101 establishes and maintains location information for distributed network environment 100. Centralized location database 101 maintains coherence of the location information and protects it from inadvertent corruption by operating system (OS) and/or memory errors. Coherence maintenance and corruption protection can proceed by techniques known in the art.

Management station 104 comprises a control and monitoring entity and can communicate with the network jacks 106 deployed in distributed network environment 100. In one embodiment, the management station is centralized. In another embodiment, the management station does not comprise a single entity, but rather is distributed and/or redundant functionality.

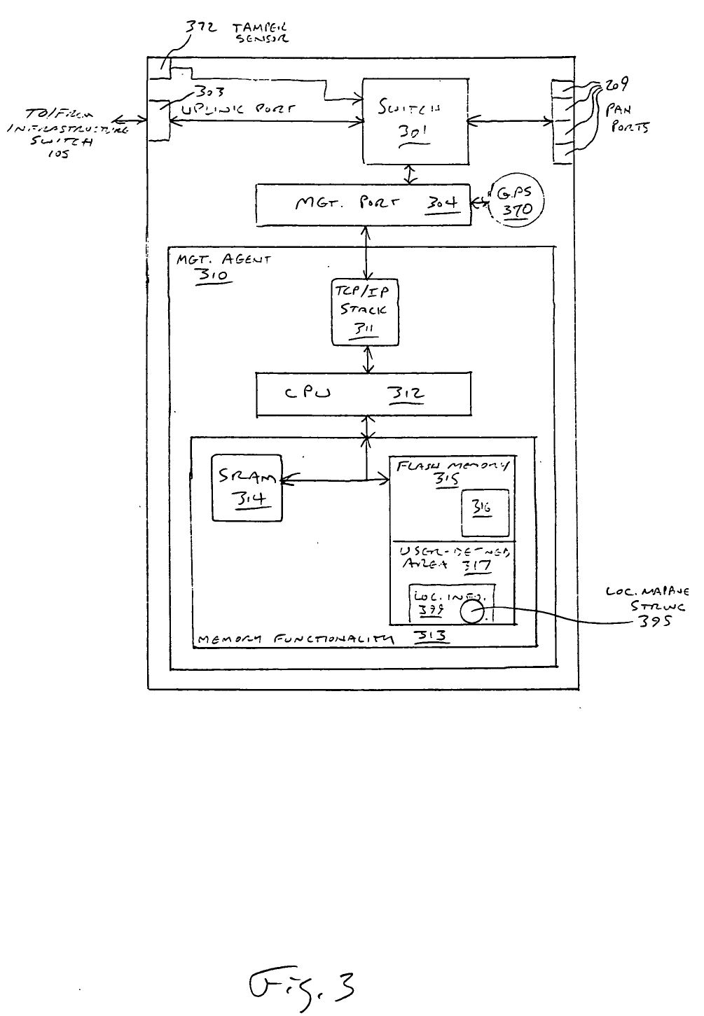

FIG. 3 depicts an intelligent network jack 106, according to one embodiment of the present invention. Network jack 106 exemplifies an intelligent device comprising the network jacks 106 of FIGS. 1 and 2. Personal area network (PAN) devices (e.g., devices 125; FIG. 1, 2) are coupled to ports 209 and can be isolated through switch 301.

Devices are connected through uplink port 303 to an infrastructure switch (e.g., switch 105; FIG. 1,2). Uplink port 303 includes or connects to a management port 304. Management port 304 couples uplink port 303 to a management agent 310. Management agent 310 provides or imparts a degree of intelligence to network jack 106. Communication between the management agent 310 and the network can be regulated or controlled using the Simple Network Management Protocol (SNMP) or a similar modality.

Switch 301, management port 304, and/or management agent 310 can act to receive location information. For instance, location information can be entered locally, such as during preparations for installation and/or programming of NJU 116. Switch 301, management port 304, and/or management agent 310 can also act to secure the accuracy of its stored location information. For instance, after programming, a lockout can be set so as to prohibit any change to this information without invoking a security protocol, such as a password or other technique.

Management agent 310 includes a Transfer Control Protocol/Internet Protocol (TCP/IP) stack 311. TCP/IP stack 311 is coupled to a processor, exemplified by central processing unit (CPU) 312. CPU 312 is coupled to a memory functionality 313. Memory functionality 313 includes a static memory feature, exemplified by static random access memory (SRAM) 314.

Memory functionality 313, in one embodiment, includes a flash memory 315. Flash memory 315 is configurable. A content secure area 316 is included, as well as a user defined area 317. In one embodiment, user defined area 317 contains information 399 that can be defined by a user. Information 399 can comprise locational information relating to a network, as connected through uplink port 303, such as a location map string 395.

It can occur that the accuracy of the databased network location information degrades over time (e.g., reflects informational entropy). Such degradation invalidates the location information within the network jack 106 and corrupts the database information. This degradation can result from various sources and/or conditions.

For instance, a network jack may be replaced with a different unit, e.g., as part of an upgrade rollout. The new unit may inadvertently not be programmed with correct location information at installation. Another example, which can be troublingly not uncommon in conventional network environments, is network jacks being swapped, such as for a quick fix to replace a failed unit, or as part of debug action to locate and/or isolate a fault.

Intelligent network jack 106 includes, in one embodiment, a tamper detection sensor 372. Tamper detection sensor can be a receptacle for a piece of mounting hardware such as a mounting screw that is for instance electronically and/or electromechanically configured, for instance, to detect an effort at removing a piece of mounting hardware.

From such detection, it can be inferred that the location of the network jack may have physically changed. Tamper detection sensor 372 can generate a tamper signal to the management agent 310. Management agent 310 can generate a corresponding location information corruption alert to a management station and central database (e.g., management station 104, central database 101; FIG. 1).

Referring also to FIG. 1 again, where network jacks 106 comprise intelligent devices, location map information (e.g., location mapping string 395) is provided, to central database 101. Central database 101 stores this location information. The information is retrievable, such as by management center 104.

The ability for information 399 to be corrected as necessary, e.g., as the location of network jack 106 changes, allows the coherence of the location information stored in the central database 101 to be maintained. Advantageously, maintaining the coherence of location information in central database 101 helps ensure that the valuable location information therein remains accurate, and is accurate when used.

Central database 101 and/or management center 104 log changes to location information and maintain files reflecting these logs. When possible corruption of the location information in central database 101 is detected or inferred, alert messages are generated. Advantageously, such alerts can trigger automatic investigative polling of intelligent network jacks, and/or allow dispatch of troubleshooting.

In one embodiment, location information 399 incorporates an embedded check sum. In one exemplary pre-defined format for location information 399, location map string 395, to be entered into flash memory 315. Corruption of the location information characterized by a hard error can be detected at installation, for instance as the location information is read locally by an installer. Alternatively or additionally, the corruption can be detected at the central database 101 upon uploading from the intelligent network jack 106.

After installation, periodic checking by CPU 312 of flash memory 315 location content for corruption such as a memory error or an inadvertent overwrite is detectable and reportable as an alert message. Such periodic checking can comprise part of a more general memory check strategy and can also be performed as a focused check.

Exemplary Processes

Exemplary Process for Maintaining Locational Database Coherence

FIG. 4 is a flowchart of an exemplary process 40 for maintaining coherence in a network locational database, according to an embodiment of the present invention. Process 40 begins with step 41, wherein network valuable locational information (such as the physical location of each of network jacks 106; FIG. 1) is initially configured.

In step 42, the network (e.g., network environment 100; FIG. 1) is monitored, so as to detect any changes from which changes in the accuracy of databased locational information can be inferred. In step 43, it is determined whether any such changes are detected. If not, process 40 repeats step 42, thus continuing to monitor for such changes.

If it is determined that a change is detected wherein it may be inferred that the accuracy of databased locational information has changed, then in step 44, the impact of those changes on the accuracy of the locational information databased is assessed. In step 45, it is determined whether the impact on location informational accuracy is significant.

If it is determined that the impact on location informational accuracy is not significant, process 40 repeats step 42, thus continuing to monitor for such changes. If it is determined that the impact on location informational accuracy is significant, then in step 46, a procedure is initiated to update and/or correct the location information, completing process 40.

Initial configuration of network jack location information (e.g., step 41 or process 40; FIG. 4) can comprise accurate data entry into individual network jacks at the time they are installed. For instance, installations standards comprise, in one embodiment, specifications to control the entry of accurate locational information.

Exemplary Process for Initial Location Information Configuration

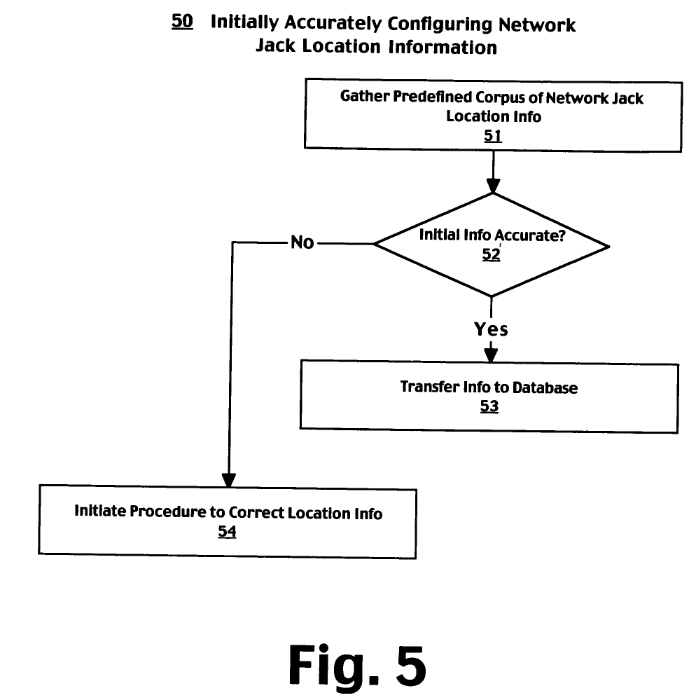

FIG. 5 is a flowchart of a process 50 for initial accurate configuration of network jack location information, according to one embodiment of the present invention. Process 50 begins with step 51, wherein a predefined corpus of information relating to the location of a network jack to become part of a distributed network of network jacks (e.g., distributed network 100; FIG. 1 )is gathered.

Gathering this information can be made accurately at installation time. Various techniques known in the art can be used. For instance, an installer of a network jack can scan information from a label or component of the network jack being installed using a bar code reader into a portable computing device, such as a palmtop or a laptop computer configured to store the data being read, or another such device.

In step 52, it is determined whether the initially gathered information is accurate. Various procedures known in the art can be used. For instance, where a network jack is installed in a location having a specifically listed room number, a corresponding numeric entry can be made. The numeric entry can comprise a check sum, which can be confirmed to ensure accuracy of the initially gathered information.

Any such verification technique can be used in various embodiments. For instance, in one embodiment, a global positioning system (GPS) device is coupled to a network jack (e.g., network jack 106; FIG. 1-3). Location information ascertained by the GPS device is transferred to a data storage functionality of the network jack (e.g., transferred via management port 304 into flash memory 315; FIG. 3).

In step 53, the information is transferred to a database (e.g., central database 101; FIG. 1). The information can be transferred by downloading the information from the storage (e.g., the palm top/lap top) into a central repository (e.g., central storage unit 101; FIG. 1). Such transferal can be accomplished via the network (e.g., distributed network 100; FIG. 1).

Exemplary Process for Post-Installation Corruption Detection

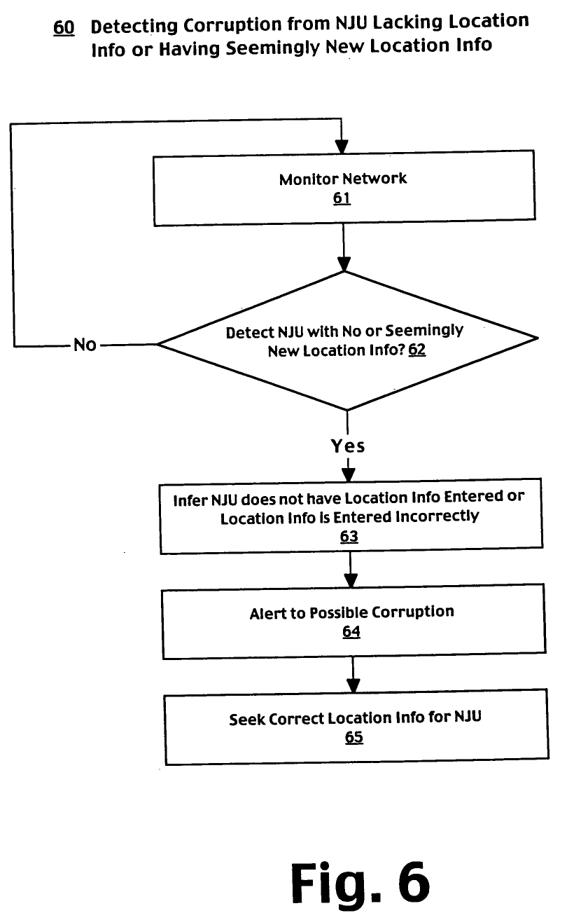

FIG. 6 is a flowchart of an exemplary process 60 for detecting corruption of location information after installation of a network jack, according to one embodiment of the present invention. Process 60 begins with step 61, wherein a distributed network of network jack units (NJU) is monitored.

In step 62, it is determined whether a network jack unit is detected wherein the network jack unit does not have location information, or wherein the network jack unit has location information that is seemingly new, such as from the perspective of a location database and/or a network management center. If not, then step 61 is repeated.

If a network jack unit is detected wherein the network jack unit does not have location information, then in step 63 it is inferred that the network jack unit does not have location information entered. If a network jack unit is detected wherein the network jack unit has location information that is seemingly new, then in step 63 it is inferred that the network jack unit may have location information that is incorrectly entered.

In step 64, an alert is generated as to possible corruption of location information. In step 65, correct location information is sought for the network jack unit, completing process 65.

Exemplary Process for Detecting New Location Mapping Information

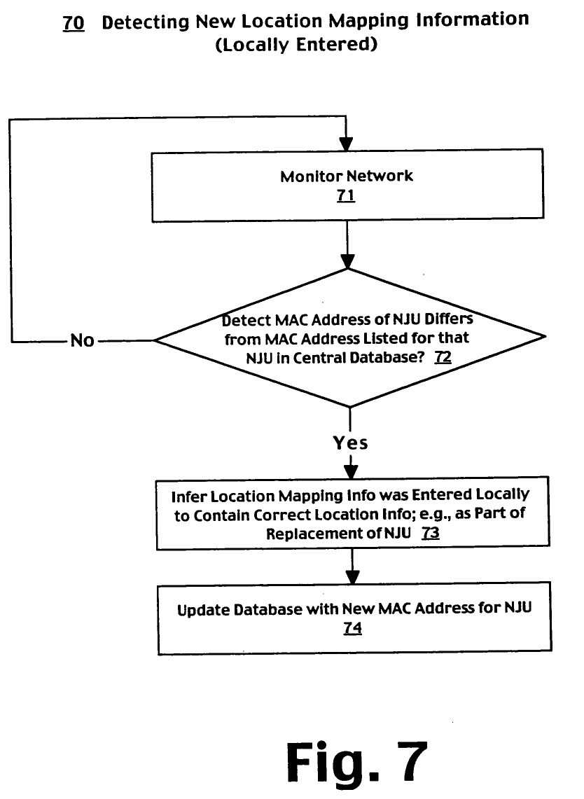

FIG. 7 is a flowchart of an exemplary process 70 for detecting new location mapping information after installation of a network jack, according to one embodiment of the present invention. Although this is in fact a proper, normal occurrence (which can be beneficial), it is desirable for a network management center and location database to apprised that it has occurred.

Process 70 begins with step 71, wherein a distributed network of network jack units (NJU) is monitored. In step 72, it is determined whether a media access control (MAC) address of a network jack unit is detected wherein that MAC address differs from the MAC address associated with that network jack unit in a location database.

While monitoring the network, a network management center may communicate with a certain network jack unit at a particular location. Upon communicating with the replacement unit, its MAC address is ascertained; MAC addresses are unique. Upon ascertaining this MAC address, it can be compared with that associated in a central location database with the network jack unit known to have resided there. If not, then step 71 is repeated.

If a network jack unit is detected wherein that MAC address differs from the MAC address associated with that network jack unit in a location database, then in step 73 it is inferred that the network jack unit has location mapping information associated with it, which was entered locally so as to be accurate. For instance, such accurate location mapping information can be locally entered as part of a procedure for replacing a network jack unit.

However, locally entered location information needs to be addressed by the network management center (e.g., entity) because the occurrence of activities such as replacement and swapping of units opens up a potential for the introduction of location information errors. For example, consider a situation in which multiple NJUs are being swapped at once, such as part of a field upgrade.

Under field conditions, for purposes of efficiency, safety, and/or other considerations, technicians sometimes prepare several NJUs at the same time. Such preparations can include computer connection and data transfer, barcode scanning, NJU identification and/or characterization, and/or other data gathering, and in some cases, the “local” entry of location information.

However, the NJUs are installed after they have been prepared. Installation may be performed by a technician different from the technician who did the preparation. Installation field conditions can be less controlled than preparation field conditions. These factors can combine to introduce a possibility of location information error introduction. A unit assigned to go to a specific location may mistakenly be placed in a different location.

To remain confident of having available correct location information, it is desirable to a network management entity for its location database to reflect totally up to date information relating to the NJUs at all locations. In step 74, a location database is updated with the new MAC address for and to be associated with the network jack unit. This can complete Process 70.

Consider as one example of an installation mistake that can be made a situation wherein two NJUs, each have valid location information entered, for instance during their preparation. Each assigned to different specific locations, they each have valid and unique location information. However, during installation, the units are mistakenly swapped, such as between adjacent rooms or residence addresses.

It can be difficult to detect that a swap like this has occurred. Technological solutions-exist. For instance, referring again to FIG. 3, in one embodiment intelligent NJU 106 has a global positioning system (GPS) functionality 370 installed. The shift in position as the mistaken swap occurs is detected by GPS 370 and entered into location information 399 and to its distributed network environment via uplink port 303. One embodiment does not have a GPS device installed.

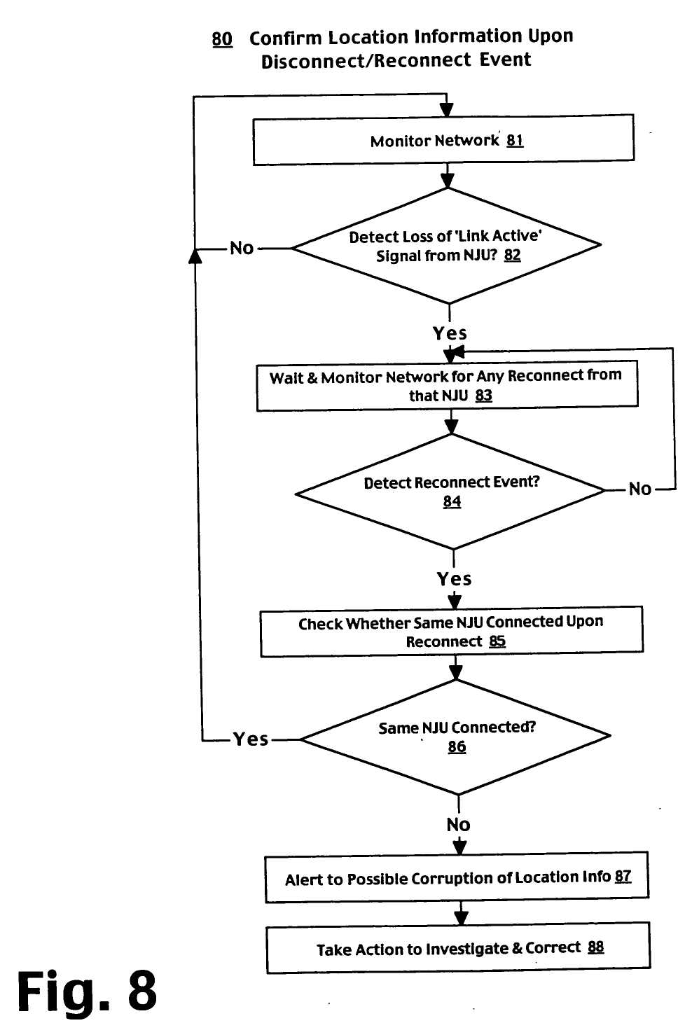

In other embodiments, procedures are used to infer some of the NJUs within a distributed network of NJUs that can be at risk of swaps having occurred. Advantageously, such procedures can limit the number of NJUs within that network that can be prone to location information error such that, in a worst case, this limited number can be manually revalidated, locally.

Where a swap occurs on an active distributed network, several approaches, such as those exemplified by process 80, 90, 10, and 1100 (FIGS. 8, 9, 10, and 11, respectively) below can be used to detect the removal and subsequent reappearance of a specific NJU.

Exemplary Process for Confirming Location Information Upon a Disconnect/Reconnect Event

FIG. 8 is a flowchart of an exemplary process 80 for confirming location information upon a disconnect/reconnect event, according to one embodiment of the present invention. Process 80 begins with step 81, wherein a distributed network of network jack units (NJU) is monitored.

In step 82, it is determined whether a ‘link active’ signal loss event from a network jack unit has been detected. If not, then step 71 is repeated. If a ‘link active’ signal loss event from a network jack unit is been detected (e.g., a ‘link active’ signal is lost), then in step 83, the monitoring entity waits and monitors the network (e.g., inter alia) for a reconnect event from that unit.

In step 84, it is determined whether a reconnect event has been detected (e.g., that unit reconnects). If not, step 83 is repeated. If it is determined that a reconnect event has been detected, then in step 85, an identity check is conducted. In step 86, it is determined whether the identity associated with the network jack unit reconnecting corresponds to that of the unit that was disconnected. If so, step 81 is repeated.

If it is determined that the identity associated with the network jack unit reconnecting does not correspond to that of the unit that was disconnected, then in step 87, an alert is generated as to possible corruption of location information. In step 88, action is taken to investigate and to correct the discrepancy, if necessary, completing process 80.

Exemplary Process for Verifying Location Information and Active NJU Status

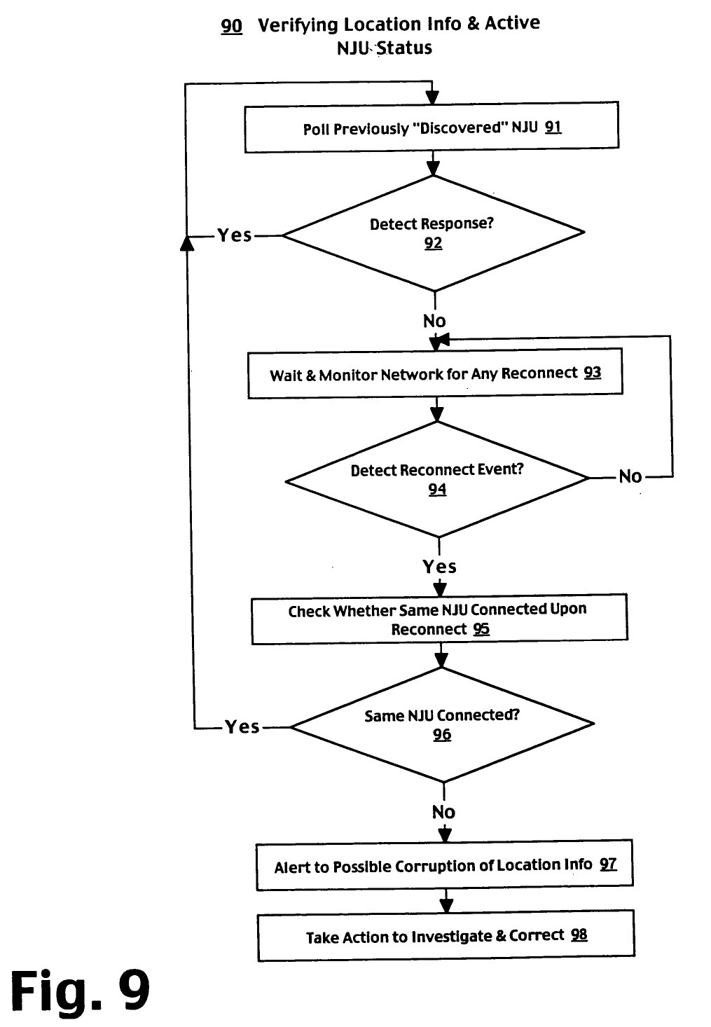

FIG. 9 is a flowchart of an exemplary process 90 for verifying location information and active status of a network jack unit (NJU) of a distributed network of network jack units, according to one embodiment of the present invention. Process 90 begins with step 91, wherein a previously discovered (e.g., known to the network as an entity thereon) is polled.

In step 92, it is determined whether a response to that polling has been detected. If so, then step 91 is periodically repeated. If a response to that polling has not been detected, such as after a specified lapse of time, then in step 93, the monitoring entity waits and monitors the network (e.g., inter alia) for a reconnect event from that unit.

In step 94, it is determined whether a reconnect event has been detected (e.g., that unit reconnects). If not, step 93 is repeated. If it is determined that a reconnect event has been detected, then in step 95, an identity check is conducted. In step 96, it is determined whether the identity associated with the network jack unit reconnecting corresponds to that of the unit that was disconnected. If so, step 91 is repeated.

If it is determined that the identity associated with the network jack unit reconnecting does not correspond to that of the unit that was disconnected, then in step 97, an alert is generated as to possible corruption of location information. In step 98, action is taken to investigate and to correct the discrepancy, if necessary, completing process 90.

Exemplary Process for Detecting a Power Loss

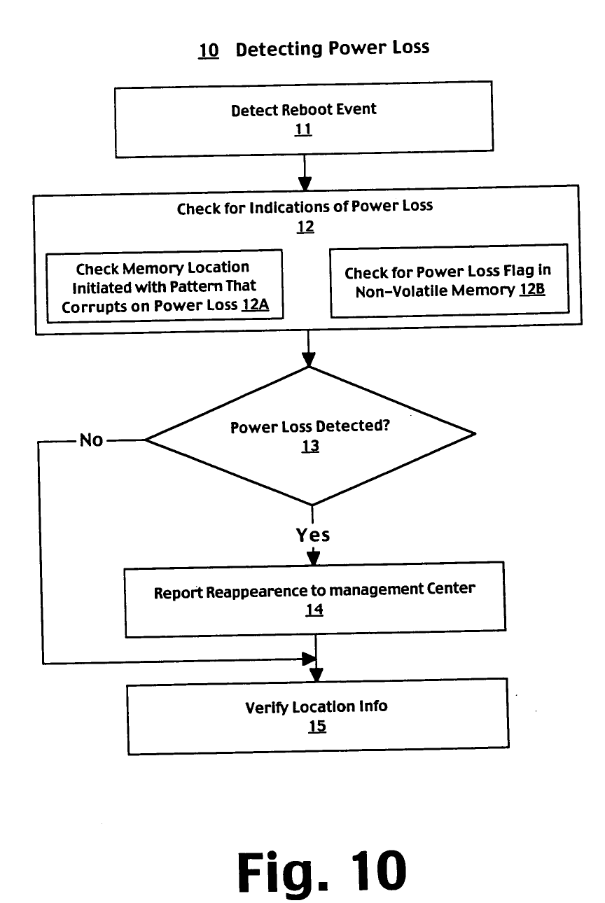

FIG. 10 is a flowchart of an exemplary process 10 for detecting a power loss in a distributed network of network jack units (NJU), according to one embodiment of the present invention. Process 10 begins with step 11, wherein a reboot event is detected on the network.

In step 12, indications of a power loss are checked for. A variety of techniques can be used to execute step 12. One exemplary technique is illustrated by step 12A, wherein a memory location is checked wherein that location initiates with a pattern that corrupts on power loss. A second exemplary technique is illustrated by step 12B, wherein a non-volatile memory functionality is checked for a power loss flag, e.g., where the power loss was detected in time to store a loss indication in the noon-olatile memory. Other techniques can be used to implement step 12.

In step 13, it is determined whether a power loss is detected. For instance, upon checking the memory location that initiates with a pattern that corrupts on power loss, a corrupted pattern is detected. For another instance, upon checking a non-volatile memory functionality, a power loss flag is detected. Other indicators can be used to detect a power loss.

If a power loss is detected, the reappearance, such as upon the reboot event, is reported to a management center. Then in step 15 (or if no power loss is detected upon the reboot event), location information is verified.

Exemplary Process for Detecting an Attempt to Move an NJU

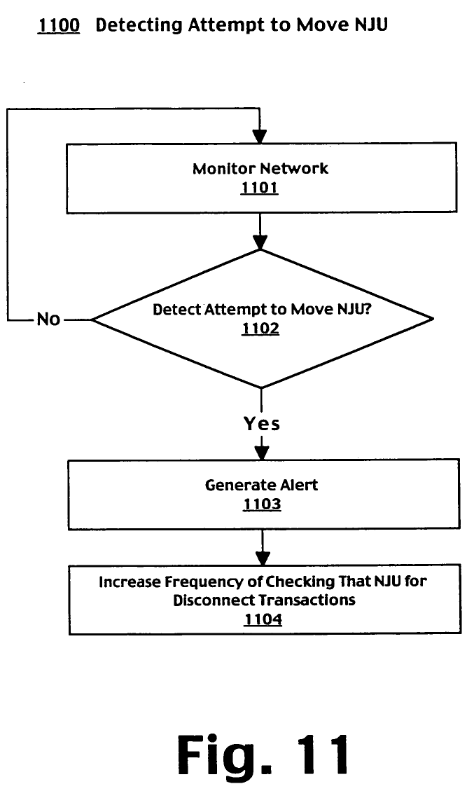

FIG. 11 is a flowchart of an exemplary process 1100 for detecting an attempt to move a network jack unit (NJU), according to one embodiment of the present invention. Process 1100 begins with step 1101, wherein the network is monitored.

In step 1102, it is determined whether an attempt to move a network jack unit has been detected. Such an attempt can be detected or inferred by a signal from a network jack unit generated, for instance by an anti-tamper mechanism (e.g., tamper detector 372; FIG. 3). If not, step 1101 is repeated.

If an attempt to move a network jack unit has been detected, then in step 1103, an alert is generated. In step 1104, the frequency is increased for checking the affected network jack unit for a disconnect transaction, completing process 1100.

Where a swap occurs on a network that was powered down at the time of the swap, a potential for topology shift exists. Under such conditions, it can be desirable to be able to discriminate between harmless transitions and those in which the likelihood or possibility of a change puts the coherency of the location mapping information at risk. In one embodiment, upon detecting such coherency-threatening conditions, location mapping can be verified.

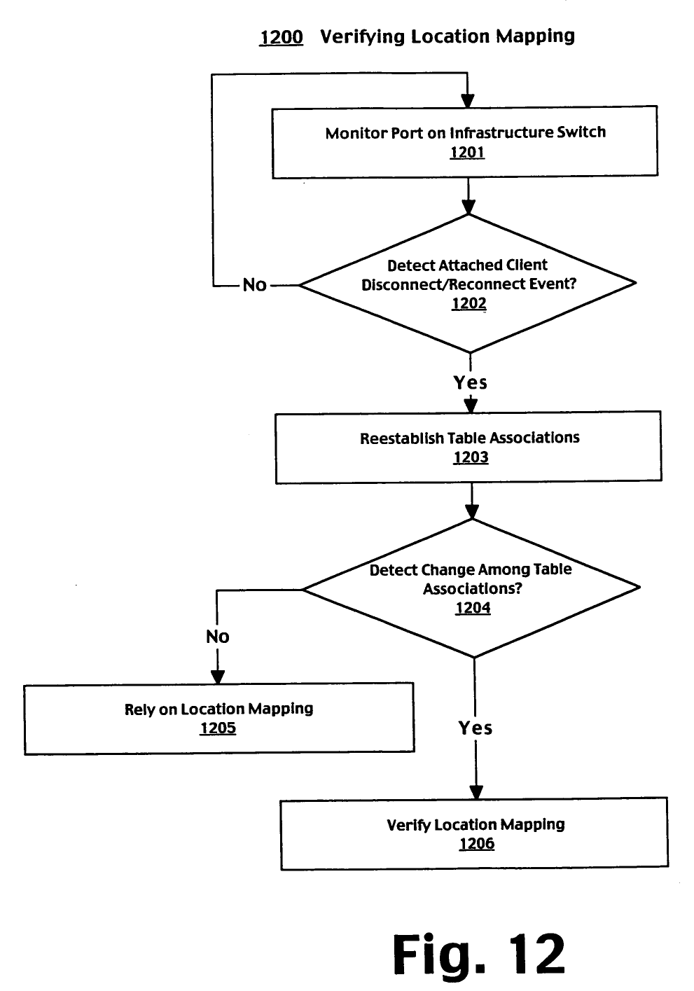

Part of a topology discovery process undertaken by a monitoring agent (e.g., management center 104; FIG. 1) can include establishing a table of infrastructure switches attached to a distributive network (e.g., switches 105, distributive network environment 100; FIG. 1). For instance, infrastructure switches can be identified by their MAC addresses assigned to their management ports.

Where an event occurs wherein an attached client (e.g., client devices 107-110; FIG. 1) is removed and reattached, or the infrastructure switch itself is taken off line and reconnected, the table associations can be reestablished. Where no changes in the table associations are detected, it can be inferred that the location mapping remains reliable. Where however there are changes to the table associations, it is inferred that the location information is not reliable. One exemplary implementation is explained by reference to FIG. 12.

Exemplary Process for Verifying Location Mapping on a Client Event

FIG. 12 is a flowchart of an exemplary process 1200 for verifying location mapping upon a client event, such as a client disconnect/reconnect, according to one embodiment of the present invention. Process 1200 begins with step 1201, wherein a port on an infrastructure switch (e.g., switch 105; FIG. 1) is monitored.

In step 1202, it is determined whether an event has been detected relating to an attached client (e.g., client device such as a computer, telephone, or other equipment). If not, step 1201 is repeated. Such an event can be exemplified by a disconnect/reconnect event.

In step 1203, upon reconnection or an analogous client event, table associations are reestablished, such as within a central database relating to the affected client device.

In step 1204, it is determined whether any change has been detected among the table associations. If not, then in step 1205, existing table associations are deemed reliable and are relied on. If any change is detected among the table associations, then in step 1206, location mapping is verified, completing Process 1200.

For instance, consider a case in which a new (e.g., previously unregistered or discovered) MAC address appears on a port. Where the location mapping information is intact, it can be inferred that the replacement can be an upgrade installation or a replacement of a failed device.

Where new location mapping information is detected, other ports are checked to attempt to detect whether a port swap could have occurred. A port swap can be indicated by previously known MAC addresses and location mapping information appearing to have moved between ports on a switch.

Where a swap occurs at a switch within intervening wiring, location mapping remains intact. Where NJUs get swapped between physical locations, the integrity of their location mapping information becomes invalid. In one embodiment, NJUs are secured with security screws and/or tamper detectors so as to restrict swapping to “authorized” personnel, who can be assumed to realize the need to maintain location mapping integrity.

In one embodiment, time domain reflectometry (TDR) or similar cable length measuring techniques can be used to provide additional location information, based on a cable length. Using such a technique, discrimination can be made between benign port swaps at the switch and those involving physical changes to NJU locations, which can corrupt location information. For instance, using TDR to ascertain a cable length, that data can be added to the port MAC address association table.

In one embodiment, the duration of a power down period can provide a discriminating factor between benign changes and location data corrupting changes. For instance, a power outage duration can be ascertained by a central controller (e.g., management center 104; FIG. 1) tracking time since a last successful poll. A power-down of the monitoring entity itself can be detected by periodic tracking of last alive time stamps taken by the monitoring station or stations, to reactions to a power fail interrupt, or related methods.

Based on how long a network was powered down, certain inferences can be drawn relating to location information coherence. For instance, where a substantial fraction of units were off line during the same, relatively short period of time, it can be inferred that the cause was a power loss followed by a restore event, such as a power transient.

In such a case, it can be further inferred that the likelihood that units had been moved (which could threaten location information coherence) during the power down is small. If the duration of the outage was longer, it can be inferred that the location mapping integrity for the affected portion of the distributed network could be corrupted. Steps can be taken to alert to this possibility and to correct the coherence.

Where the status of infrastructure switches, such as “closet” switches is monitored, further inferences can be drawn. For instance, where many or all of the NJUs connected to a particular switch go down at the same time and the closet switch stays alive, it can be inferred that connections to the NJUs could have been broken in a wiring closet or at a cross connect element in the wiring. This information can be desirable, even though the event does not necessarily threaten location mapping data, since the NJUs had no opportunity to be moved.

Exemplary Process for Discriminating Between Benign and Possibly Corrupting Network Changes

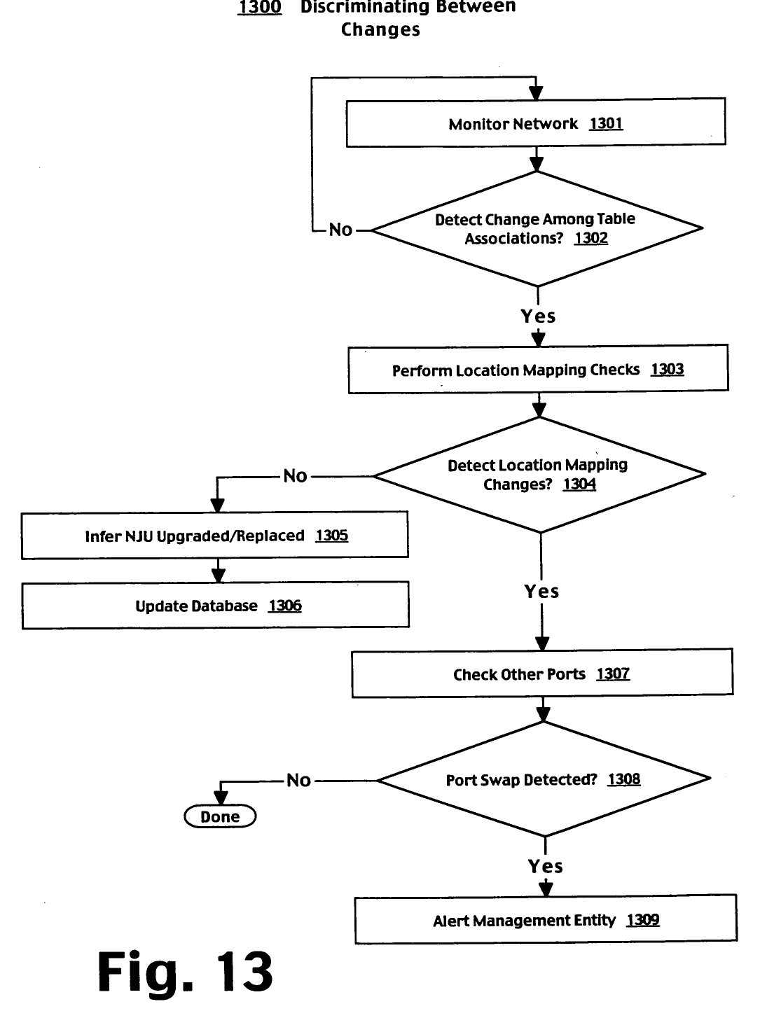

FIG. 13 is a flowchart of an exemplary process 1300 for discriminating between a benign network configuration changes and those which can imply possible location information corruption, according to one embodiment of the present invention. Process 1300 begins with step 1301, wherein a distributed network is monitored.

In step 1302, it is determined whether a change in table associations is detected. If not, step 1301 is repeated. If a change in table associations is detected, then in step 1303, location mapping checks are performed. In step 1304, it is determined whether there are location mapping changes. If it is determined that there are no location mapping changes, then in step 1305, it is inferred that the affected NJU was upgraded or replaced.

If it is determined that there are location mapping changes, then in step 1306, other ports are checked, such as for devices having a MAC number corresponding to that of the affected NJU, which could be indicative of a port swap. In step 1307, it is determined whether a port swap has been detected. If not, process 1300 can be complete. If a port swap is detected, then in step 1308, a management authority is alerted, completing process 1300.

Exemplary Process for Inferring Location Information Reliability from Outage Duration

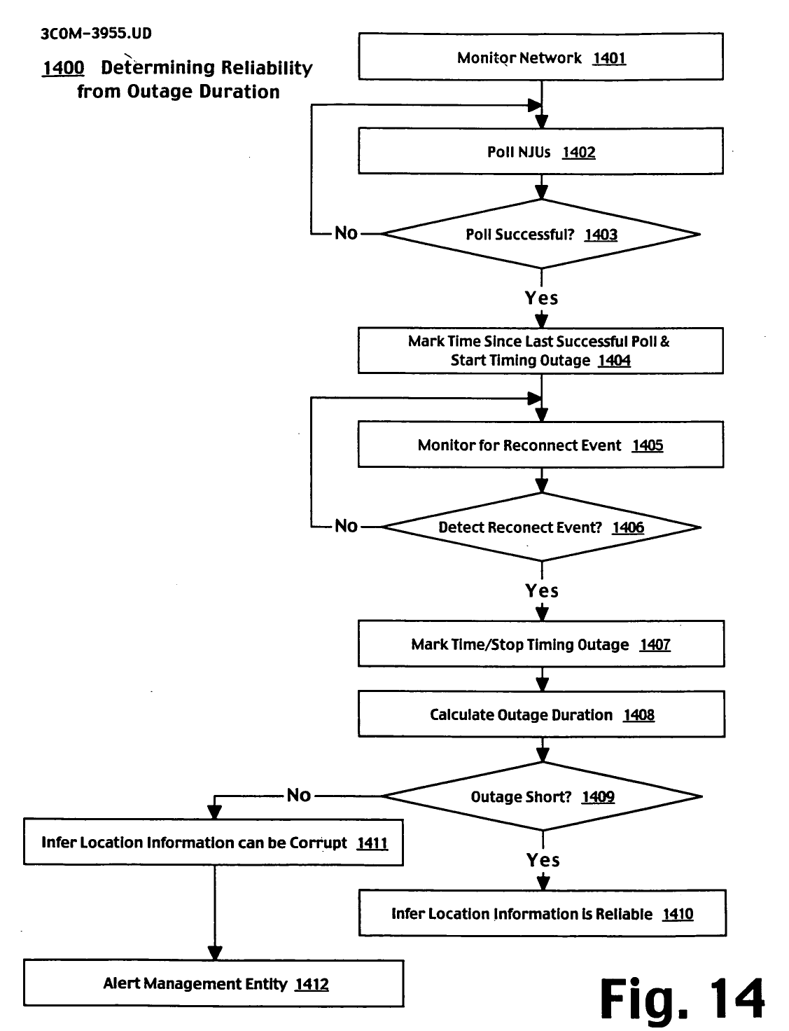

FIG. 14 is a flowchart of an exemplary process 1400 for inferring possible corruption of location information from information relating to an outage duration. Process 1400 begins with step 1401, wherein a distributed network is monitored.

In step 1402, NJUs comprising the distributed network (and/or e.g., other devices) are polled. In step 1403, it is determined whether a poll is successful. If so, step 1402 is periodically repeated. If a poll is unsuccessful, then in step 1404, the time is marked and timing since the last successful poll begins.

In step 1405, the network is monitored for a reconnect event relating to the affected NJUs. In step 1406, it is determined whether a reconnect even has been detected. If not, then step 1405 is repeated. Upon detecting a reconnect event, in step 1407 the timing is stopped for the outage duration and the time is marked. In step 1408, the duration of the outage is calculated.

In step 1409, it is determined whether the outage was short, relative to the time required to remove and reconnect a network jack, for example. If it is determined that the outage was short, then in step 1410, it is inferred that the location information is reliable. If it is determined that the outage duration was not short, then in step 1411, it is inferred that location information could be corrupt.

In step 1412, an alert is generated. In step 1413, action is taken to check on the accuracy of the related location information, completing process 1400.

As described above, a method for maintaining coherence of location information in a database, which can be centralized, of a distributed network of network jack units is disclosed. The method includes initially configuring the location information accurately, upon which the distributed network is monitored. Monitoring can be performed by a central and/or redundant management entity. Upon detecting a change in the distributed network, the significance of that change on the coherence of the location information is assessed. Upon determining that the change is significant, an action is initiated to update the database and/or take other corrective action.

In one embodiment, the location data is accurately configured initially by accurately entering location information at one of the network jack units. That location information is provided to the database. This can be performed for instance by uploading the location information from the network jack unit over the network or transferring the location information from a storage entity such as a portable data storage device.

Such portable storage devices include, but are not limited to, a computer (including a computer used to enter the location data), a dedicated data storage and transfer entity, or a portable data storage medium, such as a compact disc, diskette, universal serial bus (USB) port data loader, or the like.

In one embodiment, detecting a change in the distributed network comprises discovering that one of said network jack units lacks locally associated location information. Assessing the significance of this change can comprise inferring that the network jack unit does not have location information entered therein. This can be corrected by providing that information to the network jack unit.

In one embodiment, detecting a change in the distributed network comprises discovering that one of the network jack units has locally associated location information which seems to be new. Assessing the significance of this change can comprise inferring that the network jack unit can have location information entered therein that is incorrect. Appropriate corresponding actions can include alerting that the location information can be corrupt and correcting it.

In one embodiment, detecting a change in the distributed network comprises discovering that a media access control (MAC) address of one of the network jack units differs from a MAC address listed for that network jack in the database. Assessing the significance of this change can comprise inferring that the network jack unit can have had correct location information entered therein that is incorrect. One appropriate corresponding action can include updating the database.

One embodiment provides a method for monitoring a distributed network of network jack units to maintain coherence of location information in a database of the network. This method can comprise polling one of the network jack units wherein the network jack unit has been known (e.g., previously) to a management entity performing the monitoring. Upon detecting no response to the polling, a reconnect event relating to that network jack unit is watched for. Upon detecting a reconnect event, the identity of the network jack unit is checked.

In one embodiment, upon detecting that the identity differs from a value for an identity associated with the network jack unit that is stored in said database, it is inferred that said location information can be corrupt. A corresponding alert can be sent and an action can be taken to investigate and correct the location information.

This method can also comprise detecting a power loss to one of the network jack units and verifying the location information as related to that unit. In this embodiment, the method further comprises detecting an event and responsively checking for an indication of a power loss. The event can comprise a reboot event. If so, the checking can include checking for a power loss flag in a non-volatile memory or checking a memory location for a corrupted pattern, which with a pattern that corrupts on a power loss.

This method can also comprise detecting an attempt to move one of the network jack units. In this case, the frequency of monitoring that network jack unit, such as for a disconnect transaction, can be increased. The network jack unit can include a tamper sensor which can generating a detectable signal if an attempt is made to, for instance, remove mounting hardware, or another action implicative of a moving attempt is taken.

In one embodiment, the method can comprise detecting a change among table associations, such as in an infrastructure switch or management entity, and responsively performing a location mapping check. Upon detecting a location mapping change, it can be inferred that the network jack unit was selectively upgraded and replaced, and the database can be updated. Upon detecting no location mapping change, another port can be checked. Upon detecting a port swap, a management entity can be alerted.

A method and system for maintaining coherence of location information in a database of a distributed network of network jack units are thus described. The foregoing descriptions of specific exemplary embodiments of the present invention have been presented for purposes of illustration and description. They are not intended to be exhaustive or to limit the invention to the precise forms disclosed, and many modifications and variations are possible in light of the above teaching. The embodiments were chosen and described in order to explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

1. A method for maintaining coherence of location information in a database of a distributed network of network jack units, comprising:
accurately configuring said location information of said database of said distributed network of network jack units initially;
monitoring said distributed network of network jack units;
upon detecting a change in said distributed network, assessing the significance of said change on the coherence of said location information of said database of said distributed network of network jack units; and
upon determining that said change is significant, initiating an action to update said database of said distributed network of network jack units.

2. The method as recited in claim 1 wherein said database comprises a centralized database.

3. The method as recited in claim 1 wherein said accurately configuring comprises:
accurately entering said location information at one of said network jack units; and
providing said location information to said database.

4. The method as recited in claim 3, wherein said providing comprises an action selected from the group consisting essentially of:
uploading said location information from said network jack unit; and
transferring said location information from a storage entity.

5. The method as recited in claim 4, wherein said storage entity comprises a portable data storage device.

6. The method as recited in claim 5, wherein said portable data storage device comprises a device selected from the group consisting essentially of:
a first computer wherein said first computer comprises a computer used to perform said accurately entering;
a second computer;
a dedicated data storage and transfer entity; and
a device comprising a portable data storage medium.

7. The method as recited in claim 1 wherein said monitoring is performed by a network management entity.

8. The method as recited in claim 7, wherein said network management entity comprises an entity selected from the group consisting essentially of a central control station and a redundant control station.

9. The method as recited in claim 1, wherein said detecting comprises discovering that one of said network jack units lacks locally associated location information.

10. The method as recited in claim 9 wherein said assessing comprises inferring that said network jack unit does not have location information entered therein and wherein said action comprises providing said location information to said network jack unit.

11. The method as recited in claim 1, wherein said detecting comprises discovering that one of said network jack units has locally associated location information wherein said locally associated location information is seemingly new.

12. The method as recited in claim 11, wherein said assessing comprises inferring that said network jack unit can have location information entered therein that is incorrect and wherein said action comprises:
alerting said location information can be corrupt; and
correcting said location information.

13. The method as recited in claim 1, wherein said detecting comprises discovering that a media access control (MAC) address of one of said network jack units differs from a MAC address listed for said network jack in said database.

14. The method as recited in claim 13, wherein said assessing comprises inferring that said network jack unit has had correct location information entered therein and wherein said action comprises updating said database.

15. A method for monitoring a distributed network of network jack units to maintain coherence of location information in a database of said network, comprising:
polling one of said network jack units wherein said network jack unit has been known to a management entity performing said monitoring;
upon detecting no response to said polling, watching for a reconnect event relating to said network jack unit; and
upon detecting said reconnect event, checking an identity of said network jack unit.

16. The method as recited in claim 15 further comprising:
upon detecting that said identity differs from a value for an identity associated with said network jack unit stored in said database, inferring that said location information can be corrupt;
sending a corresponding alert; and
taking an action to investigate and correct said location information.

17. A method for monitoring a distributed network of network jack units to maintain coherence of location information in a database of said network, comprising:
detecting a power loss to one of said network jack units; and
verifying said location information as related to said network jack unit.

18. The method as recited in claim 17 wherein said method further comprises:
detecting an event; and
responsive to detecting said event, checking for an indication of a power loss, wherein said checking is performed prior to said detecting a power loss.

19. The method as recited in claim 17 wherein said event comprises a reboot event and wherein said checking comprises an action selected from the group consisting essentially of checking for a power loss flag in a non-volatile memory and checking a memory location for a corrupted pattern wherein said memory location initiates with a pattern that corrupts on a power loss, and wherein said non-volatile memory and said memory location are associated with said network jack unit.

20. A method for monitoring a distributed network of network jack units to maintain coherence of location information in a database of said network, comprising:
detecting an attempt to move one of said network jack units; and
increasing a frequency of monitoring said network jack unit for a disconnect transaction.

21. The method as recited in claim 20 further comprising generating an alert.

22. The method as recited in claim 20 wherein said network jack unit comprises a tamper sensor and wherein said detecting comprises sensing a signal from said tamper sensor.

23. A method for monitoring a distributed network of network jack units to maintain coherence of location information in a database of said network, comprising:
detecting a change among table associations;
responsive to said detecting, performing a location mapping check;
upon detecting a location mapping change:
inferring that said network jack unit was selectively upgraded and replaced; and
updating said database;
upon detecting no location mapping change, checking another port; and
upon detecting a port swap, alerting a management entity.

24. A system for maintaining coherence of location information in a database of a distributed network of network jack units, comprising:
said database for storing said location information;
a network entity coupled to said database for providing access to said database and communication with said network jack units; and
a management entity coupled to said database and to said network jack units through said network entity for monitoring said distributed network of network jacks wherein said management entity comprises a computer and wherein said system performs a computerized method for said maintaining coherence of said location information in said database of said distributed network of network jack units, said method comprising:
accurately configuring said location information of said database of said distributed network of network jack units initially;
monitoring said distributed network of network jack units;
upon detecting a change in said distributed network, assessing the significance of said change on the coherence of said location information of said database of said distributed network of network jack units; and
upon determining that said change is significant, initiating an action to update said database of said distributed network of network jack units.

25. The system as recited in claim 24 wherein said database comprises a centralized database.

26. The system as recited in claim 24 wherein said accurately configuring comprises:
accurately entering said location information at one of said network jack units; and
providing said location information to said database.

27. The system as recited in claim 26, wherein said providing comprises an action selected from the group consisting essentially of:
uploading said location information from said network jack unit; and
transferring said location information from a storage entity.

28. The system as recited in claim 27, wherein said storage entity comprises a portable data storage device.

29. The system as recited in claim 28, wherein said portable data storage device comprises a device selected from the group consisting essentially of:
a first computer wherein said first computer comprises a computer used to perform said accurately entering;
a second computer;
a dedicated data storage and transfer entity; and
a device comprising a portable data storage medium.

30. The system as recited in claim 24 wherein said network management entity is selectively centralized and distributed.

31. The system as recited in claim 30, wherein said network management entity is distributed and wherein said network management entity comprises a central control station and a redundant control station.

32. The system as recited in claim 24, wherein said detecting comprises discovering that one of said network jack units lacks locally associated location information.

33. The system as recited in claim 32 wherein said assessing comprises inferring that said network jack unit does not have location information entered therein and wherein said action comprises providing said location information to said network jack unit.

34. The system as recited in claim 24, wherein said detecting comprises discovering that one of said network jack units has locally associated location information wherein said locally associated location information is seemingly new.

35. The system as recited in claim 34, wherein said assessing comprises inferring that said network jack unit can have location information entered therein that is incorrect and wherein said action comprises:
alerting said location information can be corrupt; and
correcting said location information.

36. The system as recited in claim 24, wherein said detecting comprises discovering that a media access control (MAC) address of one of said network jack units differs from a MAC address listed for said network jack in said database.

37. The system as recited in claim 36, wherein said assessing comprises inferring that said network jack unit has had correct location information entered therein and wherein said action comprises updating said database.

38. In a computer system, a computer usable medium having a computer readable program code embodied therein for causing said computer system to execute a method for maintaining coherence of location information in a database of a distributed network of network jack units, said method comprising:
accurately configuring said location information of said database of said distributed network of network jack units initially;
monitoring said distributed network of network jack units;
upon detecting a change in said distributed network, assessing the significance of said change on the coherence of said location information of said database of said distributed network of network jack units; and
upon determining that said change is significant, initiating an action to update said database of said distributed network of network jack units.

39. The computer usable medium as recited in claim 38 wherein said database comprises a centralized database.

40. The computer usable medium as recited in claim 38 wherein said accurately configuring comprises:
accurately entering said location information at one of said network jack units; and
providing said location information to said database.

41. The computer usable medium as recited in claim 40, wherein said providing comprises an action selected from the group consisting essentially of:
uploading said location information from said network jack unit; and
transferring said location information from a storage entity.

42. The computer usable medium as recited in claim 41, wherein said storage entity comprises a portable data storage device.

43. The computer usable medium as recited in claim 42, wherein said portable data storage device comprises a device selected from the group consisting essentially of:
a first computer wherein said first computer comprises a computer used to perform said accurately entering;
a second computer;
a dedicated data storage and transfer entity; and
a device comprising a portable data storage medium.

44. The computer usable medium as recited in claim 38 wherein said monitoring is performed by a network management entity.

45. The computer usable medium as recited in claim 44, wherein said network management entity comprises an entity selected from the group consisting essentially of a central control station and a redundant control station.

46. The computer usable medium as recited in claim 38, wherein said detecting comprises discovering that one of said network jack units lacks locally associated location information.

47. The computer usable medium as recited in claim 46 wherein said assessing comprises inferring that said network jack unit does not have location information entered therein and wherein said action comprises providing said location information to said network jack unit.

48. The computer usable medium as recited in claim 38, wherein said detecting comprises discovering that one of said network jack units has locally associated location information wherein said locally associated location information is seemingly new.

49. The computer usable medium as recited in claim 48, wherein said assessing comprises inferring that said network jack unit can have location information entered therein that is incorrect and wherein said action comprises:
alerting said location information can be corrupt; and
correcting said location information.

50. The computer usable medium as recited in claim 38, wherein said detecting comprises discovering that a media access control (MAC) address of one of said network jack units differs from a MAC address listed for said network jack in said database.

51. The computer usable medium as recited in claim 50, wherein said assessing comprises inferring that said network jack unit has had correct location information entered therein and wherein said action comprises updating said database.
